(19) United States
(12) Patent Application Publication
(10) Pub. No.: US 2023/0162890 A1
(43) Pub. Date: May 25, 2023

(54) CABLE SIGNAL TRANSMISSION SYSTEM

(71) Applicant: Mitsubishi Electric Corporation, Tokyo (JP)

(72) Inventors: Koji SHIBUYA, Tokyo (JP); Tetsu OWADA, Tokyo (JP)

(73) Assignee: Mitsubishi Electric Corporation, Tokyo (JP)

(21) Appl. No.: 18/159,441

(22) Filed: Jan. 25, 2023

Related U.S. Application Data
(63) Continuation of application No. PCT/JP2020/034579, filed on Sep. 11, 2020.

(51) Int. Cl. H01B 11/00; H01B 7/00

(52) U.S. Cl. CPC H01B 11/00; H01B 7/0009

(57) ABSTRACT

A cable signal transmission system according to the present disclosure includes a differential driver to generate a differential signal between a positive phase signal and a negative phase signal from a signal inputted to the differential driver, a splitter to split the positive phase signal into two or more split positive phase signals, and to split the negative phase signal into two or more split negative phase signals, and a multi-core cable having four or more cores and connected to the splitter, to separately transmit each of the signals after the splitting by the splitter. In the multi-core cable, each of the following inner cables: two or more inner cables via which the split positive phase signals are transmitted and two or more inner cables via which the split negative phase signals are transmitted is disposed contiguously.

### CROSS REFERENCE TO RELATED APPLICATIONS

This application is a Continuation of PCT International Application No. PCT/JP2020/034579, filed on Sep. 11, 2020, all of which is hereby expressly incorporated by reference into the present application.

### TECHNICAL FIELD

The present disclosure relates to a cable signal transmission system.

### BACKGROUND ART

Conventionally, a technique related to a cable for differential signals which is used in order to transmit a high-speed digital signal of several Gbps or higher is disclosed. In a technical field for cables for differential signals, various proposals aimed at providing an improvement in the signal transmission performance and an improvement in the noise resistance have been presented (for example, Patent Literature 1).

### CITATION LIST

### Patent Literature

Patent Literature 1: JP 2011-86458 A

### SUMMARY OF INVENTION

### Technical Problem

In cable signal transmission using a conventional cable for differential signals, a cable having a configuration to include a physical grounding line, such as a conductor for shielding or a drain line has been used, for the improvement in the signal transmission performance and the improvement in the noise resistance.

It is an object of the present disclosure to provide a cable signal transmission system having a cable configuration that eliminates the need for a physical grounding line, such as a conductor for shielding or a drain line.

### Solution To Problem

A cable signal transmission system according to the present disclosure includes: a differential driver to generate a differential signal between a positive phase signal and a negative phase signal from a signal inputted to the differential driver; a splitter to split the positive phase signal into two or more split positive phase signals, and to split the negative phase signal into two or more split negative phase signals; and a multi-core cable having four or more cores and connected to the splitter, to separately transmit each of the signals after the splitting by the splitter. In the multi-core cable, each of two or more inner cables via which the split positive phase signals are transmitted is disposed adjacent to a corresponding at least one of two or more inner cables via which the split negative phase signals are transmitted.

### Advantageous Effects of Invention

Because the cable signal transmission system according to the present disclosure includes the above-mentioned configuration, a virtual perfect conductor wall (referred to as an “electric wall” hereinafter) is generated at a boundary where an inner cable for a positive phase signal and an inner cable for a negative phase signal are adjacent to each other, and functions as a grounding line. Therefore, the cable signal transmission system according to the present disclosure can eliminate the need for a conductor for shielding and a drain wire which are physical grounding lines.

### BRIEF DESCRIPTION OF DRAWINGS

FIG. 1 is a schematic view of a cable signal transmission system using a typical 2-core cable.

FIG. 2 is a schematic view showing a cable signal transmission system in Embodiment 1;

FIG. 3 is a schematic view showing a cable signal transmission system in Embodiment 2;

FIG. 4 is a schematic view showing a cable signal transmission system in Embodiment 3; and

FIG. 5 is a schematic view showing a cable signal transmission system in Embodiment 4.

### DESCRIPTION OF EMBODIMENTS

### Embodiment 1

FIG. 2 is a schematic view showing a cable signal transmission system in Embodiment 1. The cable transmission system includes: a cable portion 1b which includes a multi-core cable having four cores, the multi-core cable including two inner cables for positive phase signals and two inner cables for negative phase signals; and a differential driver 3a which serves as a differential signal source. The two inner cables for positive phase signals include positive-phase signal conductors 2p1 and 2p2 at their respective centers, and outer peripheries of the positive-phase signal conductors are covered by respective dielectrics 1a. Similarly, the two inner cables for negative phase signals include negative-phase signal conductors 2n1 and 2n2 at their respective centers, and outer peripheries of the negative-phase signal conductors are covered by dielectrics 1a. The differential driver 3a generates a positive phase signal and a negative phase signal from a high-speed digital signal. The splitter 4 splits the positive phase signal into two or more split positive phase signals, and splits the negative phase signal into two or more split negative phase signals. The two split positive phase signals after the splitting are connected to the respective positive-phase signal conductors 2p1 and 2p2. Similarly, the two split negative phase signals after the splitting are connected to the respective negative-phase signal conductors 2n1 and 2n2.

In the cable portion 1b which includes the multi-core cable, of the cable signal transmission system according to Embodiment 1, each of the two inner cables via which the positive phase signals are transmitted is disposed adjacent to the two inner cables via which the negative phase signals are transmitted. More concretely, the positive-phase signal conductors 2p1 and 2p2 are arranged diagonally, and the negative-phase signal conductors 2n1 and 2n2 are arranged diagonally.

In the cable portion 1b which includes the multi-core cable, according to Embodiment 1, at an end of the cable portion, the positive-phase signal conductors 2p1 and 2p2 are connected to respective positive phase signal output pins of the differential driver 3a serving as the differential signal source, and the negative-phase signal conductors 2n1 and 2n2 are connected to respective negative phase signal output pins of the differential driver 3a serving as the differential signal source. More specifically, the cable signal transmission system according to the present disclosure splits each of the positive and negative phase signals into split signals, and transmits these split signals using different signal conductors. The transmission destination includes a configuration that combines the split signals after the splitting into a signal and uses the combined signal.

In the cable signal transmission system according to Embodiment 1, a differential line through which the positive phase signals and the negative phase signals are transmitted is formed. Further, because in the cable signal transmission system of the present disclosure the positive phase signals are arranged in such a way as to be adjacent to the negative phase signals, electric walls 10a and 10b are formed between the positive phase signals and the negative phase signals. These electric walls 10a and 10b function as virtual grounding lines.

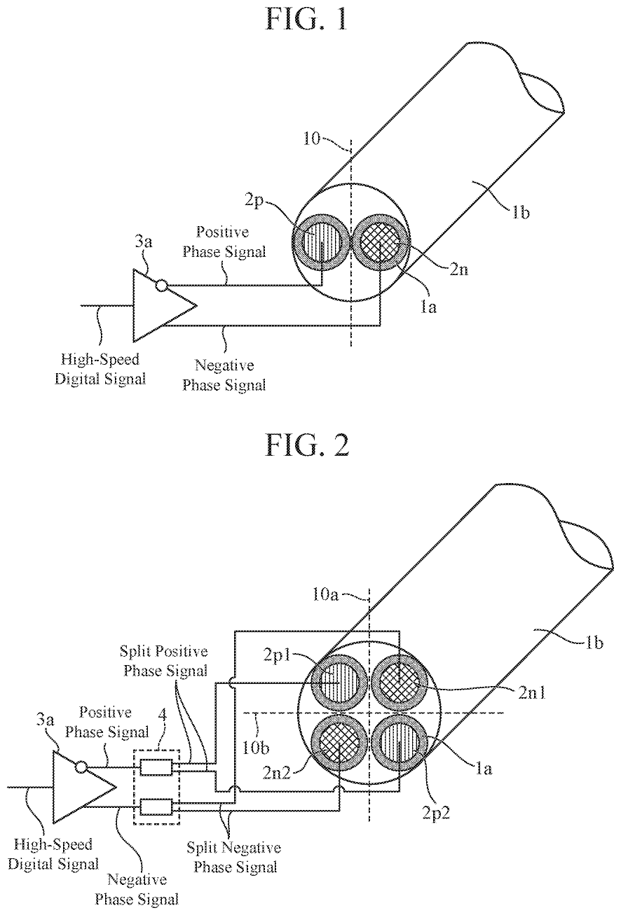

An advantageous effect provided by the cable signal transmission system according to Embodiment 1 becomes clear by comparing this embodiment with a case of transmitting a positive phase signal and a negative phase signal without splitting each of these signals. FIG. 1 is a schematic view of the case of transmitting a positive phase signal and a negative phase signal without splitting each of these signals. Although an electric wall 10 is formed between the positive phase signal and the negative phase signal even in this case, the quantity of electric wall formed is small compared with that of the cable signal transmission system according to Embodiment 1 shown in FIG. 2. It is seen that the splitting of each of the positive and negative phase signals into split signals forms a larger quantity of electric walls.

As mentioned above, in the cable signal transmission system according to the present disclosure, while the cable portion 1b itself uses a multi-core cable having a typical configuration, the cable portion 1b is split-connected to the differential driver 3a serving as a differential signal source, and, as a result, there achieves a transmission form for differential signals in which many virtual grounding lines are generated, so that the improvement in the resistance of the whole of the cable transmission system to noise can be provided. Therefore, the cable signal transmission system according to the present disclosure can eliminate the need for a conductor for shielding and a drain line which are physical grounding lines. Further, because not a cable having a special configuration, but a typical cable having a low cost which is ordinarily used can be used, a cost reduction can be expected.

### Embodiment 2

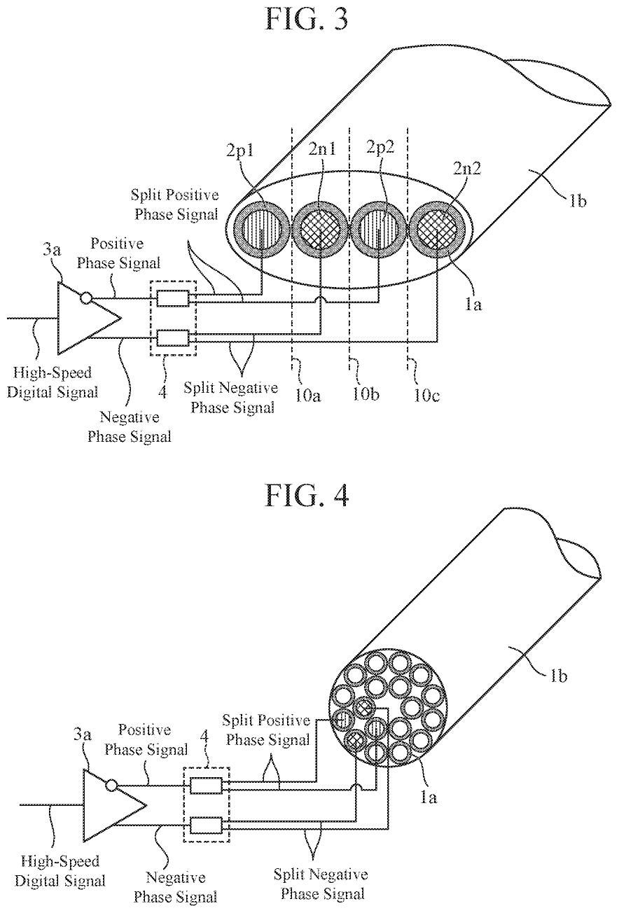

FIG. 3 is a schematic view showing a cable signal transmission system in Embodiment 2. In Embodiment 1, the mode in which a multi-core cable in which four cores are arranged in a ring shape is used as the cable portion 1b of the cable signal transmission system has been explained. In Embodiment 2, a mode in which as a cable portion 1b, a multi-core cable which similarly has four cores, but in which the four cores are arranged in a line is used will be explained.

There is no difference between Embodiment 1 and Embodiment 2, except for the configuration of the cable portion 1b. Therefore, in order to avoid a repetitive explanation, an explanation about the common portion will be omitted. FIG. 3 shows that electric walls 10a, 10b and 10c are formed even in the case where the cable portion 1b that includes a multi-core cable in which four cores are arranged in a line is used. Likewise, it is seen that in this case, a larger quantity of electric walls is formed as compared with the case shown in FIG. 1 where a positive phase signal and a negative phase signal are transmitted without splitting each of these signals.

Also in the case of the mode shown in Embodiment 2, in the cable signal transmission system according to the present disclosure, while the cable portion 1b itself uses a multi-core cable having a typical configuration, the cable portion is split-connected to a differential driver 3a serving as a differential signal source, and, as a result, there achieves a transmission form for differential signals in which many virtual grounding lines are generated, so that the improvement in the resistance of the whole of the cable transmission system to noise can be provided. Therefore, the cable signal transmission system according to the present disclosure can eliminate the need for a conductor for shielding and a drain line which are physical grounding lines. Further, because not a cable having a special configuration, but a typical cable having a low cost which is ordinarily used can be used, a cost reduction can be expected.

### Embodiment 3

FIG. 4 is a schematic view showing a cable signal transmission system in Embodiment 3. In each of Embodiments 1 and 2, the mode in which the cable portion 1b that includes a multi-core cable having four cores is used as the cable portion 1b of the cable signal transmission system is explained. In Embodiment 3, a mode in which a cable portion 1b that includes a multi-core cable having five or more cores is used as a cable portion 1b of a cable signal transmission system will be explained. FIG. 4 shows the cable portion 1b that includes a multi-core cable having eighteen cores. In the cable signal transmission system in Embodiment 3, four inner cables which are adjacent to one another are used out of the five or more inner cables, and the configuration of the four inner cables is determined in such a way that each positive phase signal and each negative phase signal are adjacent to each other. More specifically, in the cable signal transmission system in Embodiment 3, the cable portion 1b is a multi-core cable having five or more cores, and four inner cables are selected out of the five or more inner cables and are used in such a way that among the selected inner cables, each of two inner cables via which split positive phase signals are transmitted is disposed adjacent to two inner cables via which split negative phase signals are transmitted.

Also in the case of the mode shown in Embodiment 3, in the cable signal transmission system according to the present disclosure, while the cable portion 1b itself uses a multi-core cable having a typical configuration, the cable portion is split-connected to a differential driver 3a serving as a differential signal source, and, as a result, there achieves a transmission form for differential signals in which many virtual grounding lines are generated, so that the improvement in the resistance of the whole of the cable transmission system to noise can be provided. Therefore, the cable signal transmission system according to the present disclosure can eliminate the need for a conductor for shielding and a drain line which are physical grounding lines. Further, because not a cable having a special configuration, but a typical cable having a low cost which is ordinarily used can be used, a cost reduction can be expected.

### Embodiment 4

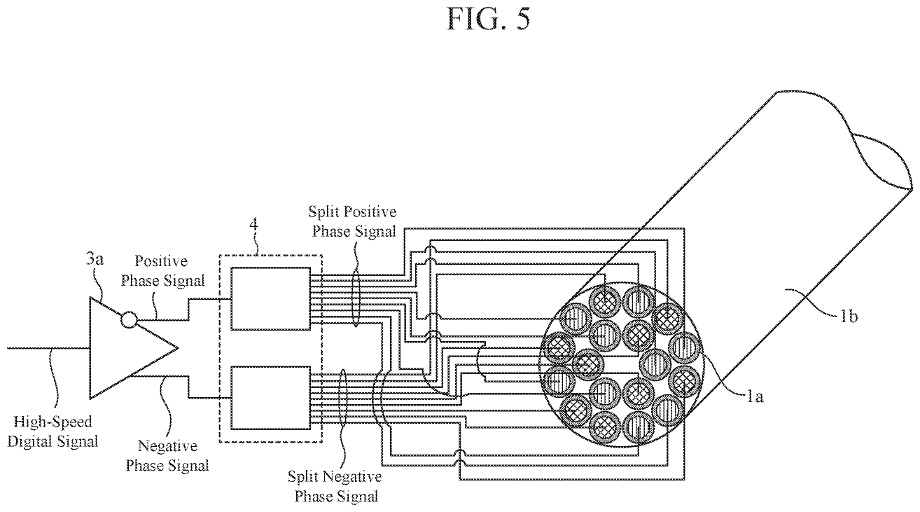

FIG. 5 is a schematic view showing a cable signal transmission system in Embodiment 4. There is a commonality between Embodiment 3 and Embodiment 4 in that a cable portion 1b which includes a multi-core cable having five or more cores is used. However, in the cable signal transmission system according to Embodiment 4, a positive phase signal of a differential driver 3a is connected to three or more signal conductors and a negative phase signal of the differential driver 3a is connected to three or more other signal conductors. FIG. 5 shows the cable portion 1b that includes a multi-core cable having eighteen cores. In the cable signal transmission system in Embodiment 4, the configuration of inner cables used is determined in such a way that a positive phase signal and a negative phase signal are adjacent to each other. In a typical example, inside the cable portion 1b which includes a multi-core cable, multiple sets of four phase signals: two positive phase signals which are arranged diagonally with each other and two negative phase signals which are arranged diagonally with each other as shown in Embodiment 1, are arranged.

It can be considered that the selection of inner cables for positive phase signals and inner cables for negative phase signals is performed as follows. First, any one of the inner cables is set in such a way that the inner cable and any other inner cable adjacent to the inner cable are not used for signals in phase, as much as possible. This is because an electric wall which functions as a virtual grounding line is not generated even when signals in phase are adjacent to each other. Further, it is desirable to make the number of positive phase signals after the splitting and the number of negative phase signals after the splitting be equal to each other. This is because the amplitude of the split positive phase signals and that of the split negative phase signals are made to be equal to each other. In a further typical example, an arrangement in which each of the inner cables for positive phase signals and a corresponding at least one of the inner cables for negative phase signals are geometrically symmetrical to each other is used.

Also in the case of the mode shown in Embodiment 4, in the cable signal transmission system according to the present disclosure, while the cable portion 1b itself uses a multi-core cable having a typical configuration, the cable portion is split-connected to a differential driver 3a serving as a differential signal source, and, as a result, there achieves a transmission form for differential signals in which many virtual grounding lines are generated, so that the improvement in the resistance of the whole of the cable transmission system to noise can be provided. Therefore, the cable signal transmission system according to the present disclosure can eliminate the need for a conductor for shielding and a drain line which are physical grounding lines. Further, because not a cable having a special configuration, but a typical cable having a low cost which is ordinarily used can be used, a cost reduction can be expected.

### Embodiment 5

A mode in which a cable signal transmission system according to the present disclosure employs a cable system which is wired in a building is also considered. Generally, in a building such as an office building, a cable system is disposed in many cases. Further, such a cable system may have an unused signal conductor. Because a cable signal transmission system according to the present disclosure can use a multi-core cable having a typical configuration, it is possible to configure a cable signal transmission system using an unused signal conductor of a cable system wired in a building.

In the cable signal transmission system according to the present disclosure like the mode shown in Embodiment 5, while a cable portion 1b itself uses a multi-core cable having a typical configuration, the cable portion is split-connected to a differential driver 3a serving as a differential signal source, and, as a result, there achieves a transmission form for differential signals in which many virtual grounding lines are generated, so that the improvement in the resistance of the whole of the cable transmission system to noise can be provided. Therefore, the cable signal transmission system according to the present disclosure can be configured using an unused signal conductor of a cable system wired in a building.

### REFERENCE SIGNS LIST

1a dielectric, 1b cable portion, 2p, 2p1, 2p2 positive-phase signal conductor, 2n, 2n1, 2n2 negative-phase signal conductor, 3a differential signal source or differential driver, 4 splitter, and 10, 10a, 10b, 10c electric wall.

1. A cable signal transmission system comprising:
a differential driver to generate a differential signal between a positive phase signal and a negative phase signal from a signal inputted to the differential driver;
a splitter to split the positive phase signal into two or more split positive phase signals, and to split the negative phase signal into two or more split negative phase signals; and
a multi-core cable having four or more cores and connected to the splitter, to separately transmit each of the signals after the splitting by the splitter,
wherein in the multi-core cable, each of two or more inner cables via which the split positive phase signals are transmitted is disposed adjacent to a corresponding at least one of two or more inner cables via which the split negative phase signals are transmitted.

2. The cable signal transmission system according to claim 1, wherein in the multi-core cable, two of the two or more inner cables via which the split positive phase signals are transmitted are arranged diagonally, and two of the two or more inner cables via which the split negative phase signals are transmitted are arranged on diagonally.

3. The cable signal transmission system according to claim 1, wherein in the multi-core cable, the two or more inner cables via which the split positive phase signals are transmitted and the two or more inner cables via which the split negative phase signals are transmitted are arranged in a line.

4. The cable signal transmission system according to claim 1, wherein the multi-core cable has five or more cores, and at least four inner cables out of the five or more inner cables are selected to be used in such a way that among the selected inner cables, each of two inner cables via which the split positive phase signals are transmitted is disposed adjacent to two inner cables via which the split negative phase signals are transmitted.

5. The cable signal transmission system according to claim 4, wherein in the multi-core cable, the inner cables are selected to be used in such a way that any adjacent two of the selected inner cables are not used for signals in phase.

6. The cable signal transmission system according to claim 4, wherein in the multi-core cable, the inner cables via which the split positive phase signals are transmitted and the inner cables via which the split negative phase signals are transmitted are equal in number.

7. The cable signal transmission system according to claim 4, wherein in the multi-core cable, each of the inner cables for the split positive phase signals and a corresponding at least one of the inner cables for the split negative phase signals are arranged in such a way as to be geometrically symmetrical to each other.
